(19) United States
(12) Patent Application Publication
(10) Pub. No.: US 2009/0099894 A1
(43) Pub. Date: Apr. 16, 2009

(54) METHOD, SYSTEM AND SOFTWARE FOR TALENT MANAGEMENT

(75) Inventors: Michael James Carden, Auckland (NZ); Mark Evan Hellier, Auckland (NZ)

Correspondence Address: FOLEY AND LARDNER LLP;SUITE 500, 3000 K STREET NW, WASHINGTON, DC, 20007, US

(73) Assignee: SONAR LIMITED

(21) Appl. No.: 12/097,504

(22) PCT Filed: Dec. 14, 2006
(86) PCT No.: PCT/NZ2006/000327

§ 371 Date: Oct. 27, 2008

(30) Foreign Application Priority Data
Dec. 16, 2005 (NZ) 544227

(51) Int. Cl. G06Q 10/00

(52) U.S. Cl. 705/8

(57) ABSTRACT

A method of analysing an individual to manage talent including step of displaying a shape of at least two dimensions within a graph of at least two axes wherein the extent of the shape within the graph is determined by at least two strengths and at least two weaknesses of the individual.

### FIELD OF INVENTION

The present invention relates to a method, system and software for analyzing and managing talent within an organisation. More particularly, but not exclusively, the present invention relates to a method, system and software for analyzing and managing talent within an organisation using a grid based on factor metrics.

### BACKGROUND TO THE INVENTION

Talent Management is the practice and process of ensuring an organisation has the capability and capacity to deliver both the operational and strategic goals of that organisation using the most appropriate resources.

Talent are all individuals within an organisation irrespective of their current position or ranking. Managing talent applies to work and understanding around those with poor performance and limited potential just as it does the star performers and high potential employees.

Talent in an organisation is measured as a combination of performance and potential; performance is a measure of how well an individual is doing today and potential is a measure of how well the individual is likely to do in the long term. To further define performance and potential each can be broken down into a set of factors, which are attributes or behaviours that the organisation believes are important for staff to have strength in.

There is a need within organisations to manage talent on a differential basis. Employees have different strengths and weaknesses even those employees performing the same role, and therefore, each employee needs to be managed differentially.

HR and General Management practice has focused on this issue for some time and there are a number of methodologies and strategies developed to work with the information collected from employees in a relative and differentiated format.

One of the most common approaches is to display employees across a grid that maps ratings on two axes usually labelled performance and potential.

The grid will often be sectioned into “boxes”. Each box is associated with a definition (for example the top-right box might be associated with “Starring”). These boxes provide support to a user's analysis of the positioning of an individual.

For example the user can quickly visually ascertain how many people displayed are grouped in the “starring” box of the grid and, from that view, begin to understand the needs and requirements for that grouping.

Unfortunately the methodologies and processes to place employees on a grid are generally arbitrary and inconsistent. Commonly employees are entered directly by the user at a position on the grid. In other methodologies people are rated against a scale for performance and a scale for potential and these results are used to then map the employee onto the grid. The subjective nature of these approaches does not lead to a consistent organizational picture of talent.

The prior art includes one such approach described in US Patent Application 2004/0012588. This document “relates generally to displaying performance characteristics and in particular, to a method and system for graphically displaying employee performance.”

In the process determined in 2004/0012588, results for performance and potential are displayed as points on a grid; the manipulation and adjustment of these results is achieved by “grabbing” data points on this grid and moving them to the desired position. This subjective approach is typical of the prior art.

The grids disclosed in the prior art are non-interactive in respect of further detail and are a simplification. Mere dots on a grid as described in 2004/0012588 do not provide sufficient information to effectively manage talent. In order to obtain a useful analysis from this information there is a need for it to be interpreted in conjunction with other information, including a person's strengths and weaknesses, their progress (whether they are improving or regressing), their variance (for example, is the person average at everything or good at a few things and also bad at a few things), as well as other employment data (for instance their pay-band).

Therefore the non-interactive and simplistic nature of the grid in the prior art enables only limited analysis and strategic value because in all cases further information must be sought from other manual and electronic systems, records, and performance and talent evaluations in order to make a useful interpretation of the information on the grid.

In addition, 2004/0012588 is only focussed on parts of an organization (such as an individual team). The arbitrary nature of how people are positioned on the grid means that if this approach was used to map an entire organisation, particularly a large organisation, the data would lack consistency and normalization and thus be very hard to interpret. In addition without a method of “filtering” or organising the data it would be too complex to understand the overall situation in the organization.

It is an object of the present invention to overcome the limitations of the above methods by providing a method for analyzing and managing talent, or to at least provide the public with a useful choice.

### SUMMARY OF THE INVENTION

According to a first aspect of the invention there is provided a method of analysing an individual to manage talent including step of:
displaying a shape of at least two dimensions within a graph of at least two axes;
wherein the extent of the shape within the graph is determined by at least two strengths and at least two weaknesses of the individual.

Preferably, the shape is a polygon such as a kite. It is preferred that each vertex of the polygon corresponds to one of the strengths or one of the weaknesses of the individual.

Preferably, there are two axes of the graph and the axes represent human resource metrics. One axis of the graph may represent performance and the other axis may represent potential.

The method may include the step of: displaying within the graph a plurality of shapes, each shape corresponding to a unique individual and extent of each shape within the graph determined by at least two strengths and at least two weaknesses of the corresponding individual.

The method may include the step of: displaying within the graph a plurality of historical shapes, the extent of each shape within the graph determined by at least two strengths and at least two weaknesses of the individual using historical data. Preferably, at least some of the historical shapes are visually faded dependent on the age of the historical data.

A plurality of shapes may be displayed on the graph, wherein at least some of the shapes are semi-transparent such that the extent of overlapping shapes can be visually determined.

It is preferred that within at least part of the shape there is an icon representing the individual.

The method may include the step of displaying further detail about the individual in response to a user action. The further detail may include an analysis of the individual created by an automated method. It is preferred that the automated method utilises the extent of the shape to determine at least part of the analysis.

According to a second aspect of the invention there is provided a method of analysing an individual positioned within a graph of at least two axes to manage talent including the step of:
displaying a directional indicator within the graph for the individual;
wherein the indicator is calculated from one or more historical positions of the individual within the graph such that the indicator shows the trend of the individual.

It is preferred that the size of the indicator is determined by the significance of change in position of the individual. It is further preferred that the indicator has a first graphical characteristic determined by the speed in change of position of the individual. This first graphical characteristic may be the length of the indicator.

The indicator may have a second graphical characteristic determined by the acceleration of change of position of the individual. The second graphical characteristic may be the thickness of the indicator.

The indicator may be calculated using an algorithm which gives more weight to earlier historical positions.

In a preferred implementation of the method the indicator is an arrow.

The method may include the step of displaying an icon representing the individual within the graph.

The method includes the step of displaying further detail about the individual in response to a user action wherein the further detail includes an analysis of the individual created by an automated method. It is preferred that the automated method utilises the characteristics of the indicator to determine at least part of the analysis.

The indicator may be curved to indicate a non-linear change of position of the individual in relation to the historical positions.

According to another aspect of the invention there is provided a method of analysing an individual for managing talent including the steps of:
displaying a first graphical representation of a first set of data of an individual in a first shade of a colour; and
displaying a second graphical representation of a second set of data for the individual in a second shade of the colour;
wherein the first set of data relates to the individual at a later time than the second set of data, and the second shade is lighter than the first shade.

The first and second graphical representations may be shapes as described in the first aspect.

The first and second graphical representations may be icons as described in the other aspects of the invention.

According to another aspect of the invention there is provided a method of analysing an individual to manage talent including the step of:
automatically calculating a talent analysis of the individual based on the position of the individual within a graph of at least two axes and at least one further characteristic of the individual;
wherein each axis of the graph represents a human resource attribute.

It is preferred that the step of automatic calculation is performed using an expert system.

Preferably the further characteristics are features of the shape described in the first aspect and/or features of the directional indicator described in the second aspect.

According to another aspect of the invention there is provided a method of analysing talent management within an organisation including the steps of:

a user defining attribute data for a plurality of individuals within the organisation using an interactive talent management tool;
determining a position for each individual within a graph using the individual's attribute data; and
displaying an icon corresponding to each individual at the position of the individual within the graph such that a range of the plurality of individuals are displayed based on an attribute selected by the user;
wherein the graph is of at least two axes and each axis corresponds to a human resource metric.

The method may include the step of displaying at least one shape associated with an icon as described in the first aspect of the invention.

Preferably, the icons are colour-coded in dependence on a factor. The factor can be any one of pay band, region, and function.

Preferably, the method includes the steps of: a user selecting a portion of the graph; and then displaying the portion of the graph larger, such that the icons within that portion are displayed further apart from one another.

The method may include the step of displaying at least one directional indicator associated with an icon as described in the second aspect of the invention.

### BRIEF DESCRIPTION OF THE DRAWINGS

Embodiments of the invention will now be described, by way of example only, with reference to the accompanying drawings in which:

FIG. 1: shows a flow diagram illustrating a method of the invention.

FIG. 2: shows a screenshot illustrating the display of a kite for an individual on a grid.

FIG. 3: shows a screenshot illustrating the display of further details related to a kite for an individual on a grid.

FIG. 4: shows a screenshot illustrating another example of the display further details related to a kite for an individual on a grid.

FIG. 5: shows a screenshot illustrating the display of an arrow for an individual on a grid.

FIG. 6: shows a screenshot illustrating the display of faded historical icons for an individual on a grid.

FIG. 7: shows a screenshot illustrating the display of faded historical kites for an individual on a grid.

FIG. 8: shows a screenshot illustrating output from an expert system.

FIG. 9: shows a screenshot illustrating the display of multiple icons representing individuals on a grid.

FIG. 10: shows a screenshot illustrating the selection by a user of filters for the icons displayed on the grid.

FIG. 11: shows a screenshot illustrating the use of colour-coded keys for icons displayed on the grid.

FIGS. 12 and 13: show screenshots illustrating a method of zooming into a portion of the grid.

FIG. 14: shows a screenshot illustrating the display of multiple analyses for an individual within a grid showing icons for multiple individuals.

FIG. 15: shows a diagram illustrating how the invention may be deployed on hardware.

### DETAILED DESCRIPTION OF PREFERRED EMBODIMENTS

The present invention relates to a method, software and system for analyzing and managing talent within an organisation using a grid based on factor metrics.

The present invention will be described in relation to a company, and the factors of employees within that company.

However, it will be appreciated by those skilled in the art that the method may be applied to other organisations.

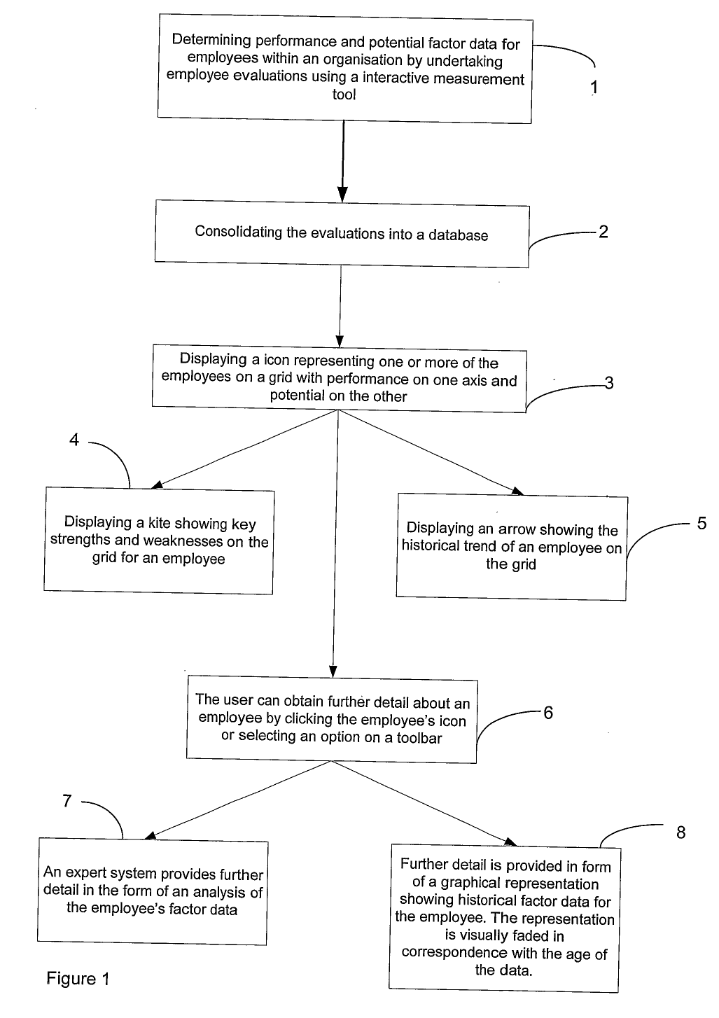

Referring to FIG. 1, an exemplary implementation of the invention will be described.

In step 1, employees are evaluated for potential and performance factors. The employees are evaluated using an interactive measurement tool. Another method of evaluation could be used, such as providing data from a manager filling in a rating survey. However, evaluation data provided from an interactive measurement tool is preferred as it provides the advantages of ease of use, ease of collation of data, provision of a more objective framework for measurement, and ease of definition or modification of that framework.

An interactive measurement tool is a GUI-based system which accepts input from a user to define a level of a factor for an individual. The tool provides guidance for the user to define the level of the factor by providing objective metrics and/or generating the level from answers to a questionnaire by the user.

Factors are attributes or behaviours that the company believes are important for staff to have strength in, and to have been measured in. For instance one performance factor is “Individual Fee Performance”.

There are a multitude of factors that can be measured. Each factor requires a definition and description of how that behaviour manifests itself and the scale by which an individual could be evaluated/ranked against that factor.

It will be appreciated that factors other than performance and potential factors can be measured such as personality traits, work style and preference, and leadership.

In step 2, the evaluations are consolidated into a central database. It will be appreciated that the evaluations could be stored within separate areas. However, it is preferred that a single central database is used because this provides the benefit of consolidation of the current employee data with historical employee data which assists later analysis.

In step 3, a grid of performance factors on the y axis to potential factors on the x axis is displayed. A position on that grid for the employee is calculated from the employee's evaluations by collating all the performance factors measurements and the potential factors measurements. For example, if the employee received 6/10 for fee performance and 8/10 for client satisfaction, the employee would be positioned at 7/10 on the y axis (performance axis). And if the employee received 3/10 for business generation ability and 7/10 for endurance, the employee would be positioned at 5/10 on the x axis (potential axis). In summary, the employee's position on the grid would be (5, 7).

It will be appreciated that the ratings are continuous, for example the employee may receive 4.56/10 for a factor.

It will further be appreciated that weighting systems may be used to give more weight to certain factors.

The employee's position on the grid can be represented by an icon.

All employees, a selection of employees, or only a single employee's position may be represented on the grid. The advantage of displaying all employees is the ability to visualize the entire organisation at a glance. The advantage of displaying a selection of employees is the ability of a manager to assess his/her team, or to compare related/similar employees across the organisation. The advantage of displaying a single employee is it enables a user to focus on one employee only.

In step 4, a kite is displayed at the position of the employee. The extent of the kite shows the key weaknesses and strengths of the employee for both factors. For example, if the employee's position is (5, 7) and their highest performance factor is client satisfaction at 8/10, then the top point of the kite would be at (5, 8) on the grid.

In step 5, the trend of the employee over time is displayed on the grid is the form of an arrow pointing at the position of the employee. The arrow is calculated from historical evaluations of the employee stored in the central database.

In step 6, further detail about an employee can be displayed by a user clicking the icon of the employee or selecting an option from a toolbar.

In step 7, the further detail is an analysis provided by an expert system which matches data about the employee extracted from the evaluations stored in the central database with data stored within a database of expert knowledge.

In step 8, the further detail is historical positions on the grid for the employee. These historical positions are represented by icons. Each icon is faded in dependence on how long ago the employee was at that position. For example, the longer ago the position the more faded the icon will be. Kites corresponding to those historical positions can also be displayed. These kites are similarly faded.

By displaying detailed information about the factors of the employees within the organisation in a simple to interpret format, this implementation of the invention has provided an analysis of the detailed information for a user. The user after viewing the displayed information is assisted in making talent management decisions

Individual aspects and variations of the invention will now be described.

### Visual Indicator of the Extent of a Person's Key Strengths and Weaknesses

From an HR perspective, when evaluating talent and how to develop that talent further, it is important to develop a rapid understanding of the key strengths and weaknesses of an individual; as well as to understand how much variance that individual has across their strengths and weaknesses. Strengths and weaknesses are defined respectively as high and low rating in the factors measured, that make up a persons overall performance or potential rating.

One method of the invention provides a graphical interpretation of a person's variance across their strengths and weaknesses. The method displays a kite within a grid based on factors. The shape of the kite is reflective of the person's variance. In addition, the kite may be clicked on by a user to display a list of the person's standout strengths and weaknesses.

The method will be described in relation to a grid divided into nine boxes. Each box is associated with a definition such that visually a user can appreciate the extent of an individual's strengths/weaknesses in relation to an objective standard. In the example, the definitions of the nine boxes are—from right-to-left, top-to-bottom: Starring, Achieving, Performing/Delivering, Progressing, Contributing, Processing, Latent, Under-contributing, and Under-Performing.

The strengths and weaknesses of individuals from a talent evaluation perspective provide an insight to not only areas for development for the individual but, when viewed in a relative perspective across an organisation or business unit, a view of key strengths and weaknesses that are consistently seen in a number of individuals across the organisation. This helps to provide information for staff coaching and training.

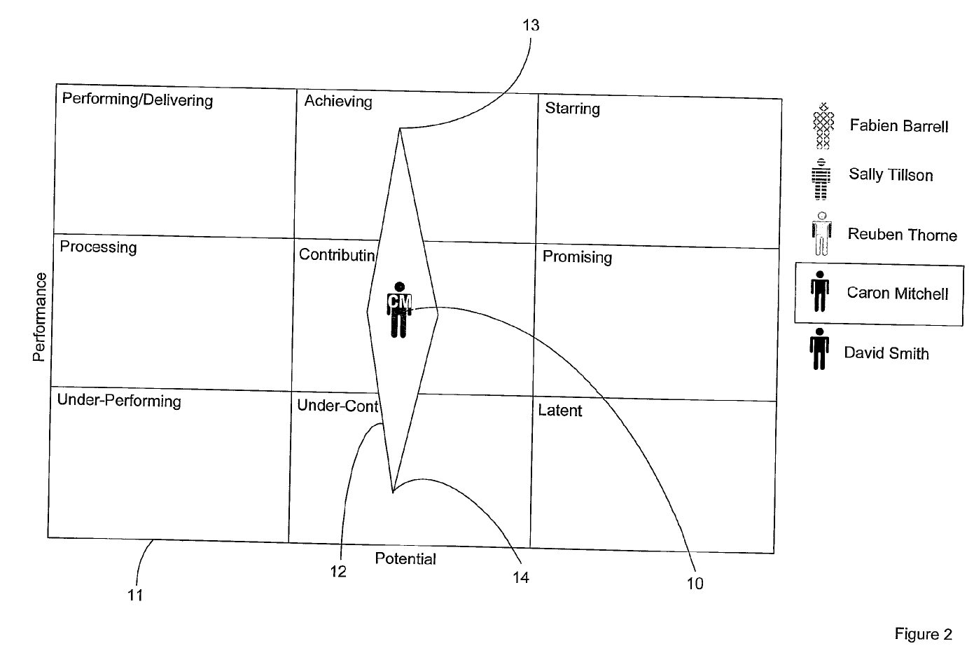

For example, FIG. 2 shows an individual 10 on a grid 11 represented by a kite 12 with extenuated strengths 13 and weaknesses 14 in the areas of performance (indicated by the length of the points vertically from the individual and relatively low levels of divergence in terms of strengths and weakness in the areas of potential).

It will be appreciated that another shape other than a kite could be used to show strengths and weakness. For example, an octagon could be used to show two strengths and two weaknesses for both performance and potential factors. However, a kite is preferred as it provides a clear view of the key strength/weakness for each factor.

In one alternative, a shape is a kite with curved points. The curves provide the ability to show multiple strengths for one factor in a visually clear method.

When overlaid onto the grid 11, the kite 12 graphically demonstrates the extent of strengths and weaknesses, and the level at which each strength and weakness pulls back or moves an individual forward in terms of the nine boxes on the grid 11.

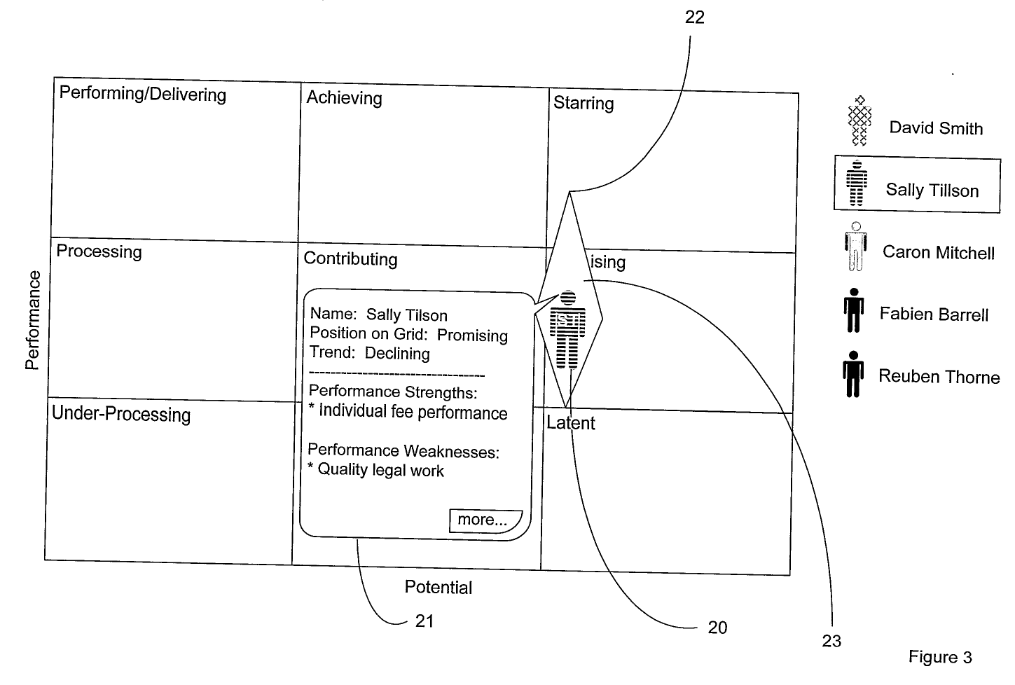

Referring to FIG. 3, when the icon 20 for employee Sally Tilson is clicked on, further details 21 about her strengths/weaknesses is displayed. For example, the performance strength indicated by the top point 22 of the kite 23 is a high level of rating in the area of individual fee performance, and a key performance weakness in terms of her evaluation has been a low rating in the area of quality legal work. As the employee has limited variance in her potential measurement (indicated by the narrow width of her kite in the potential (x axis) dimension) no standout potential strengths and weaknesses are listed.

The advantage of using this method for analysing talent within an organisation is that by including the variance of individuals' evaluations and their strengths and weaknesses it enhances a user's abilities to develop a rapid understanding of the results of a team or organisation's talent evaluation.

It will be appreciated that other metrics on the axes on the grid could be substituted and their key elements displayed graphically by the kite. Examples of alternate axes include psychometric evaluation data, personality traits, work style and preference, and leadership.

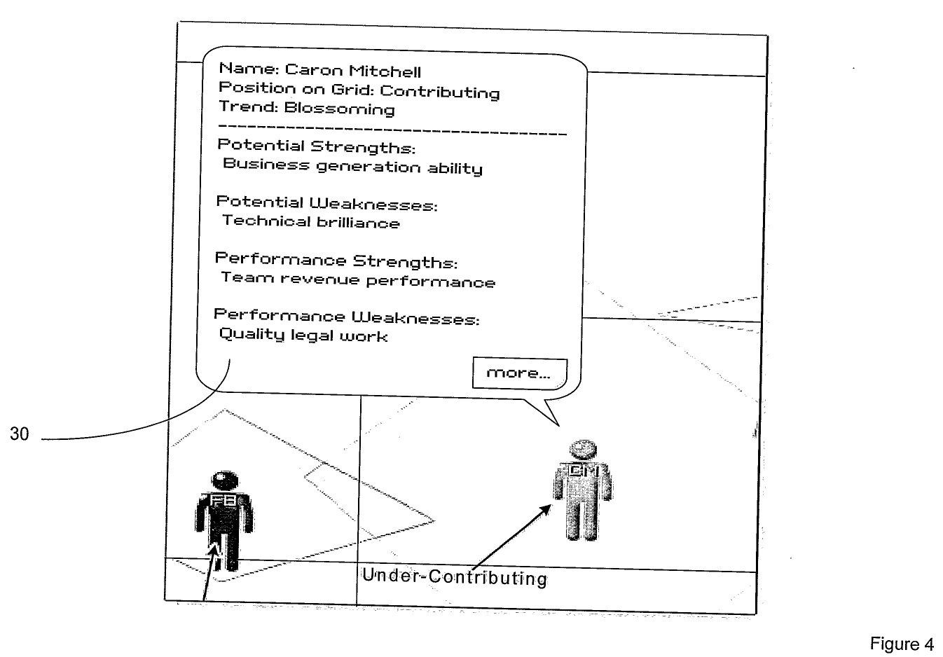

FIG. 4 shows another example of further details 30.

Employers are generally concerned at a top level with the key strengths and weaknesses of an employee from both a development and recognition perspective and the kite provides a very clear visual indication (supported by text based information) of these results.

Another difficulty in an organisation assessing the capability of many employees at once is the fact that it is impossible to do this with many pages of text or table information visible for each employee. Therefore an individual cannot be assessed as readily. The kite allows a user to view each person's summary position and quickly compare it with many other employees on the same grid.

### Visual Indicator of the Person's Trend in Relation to Key Factors

The second method of the invention is an arrow which graphically displays the movement of a person within the grid over time. This provides useful understanding of the consistency and trend of a person in relation to key factors such as performance and potential.

It will be appreciated that other visual directional indicators could be used, such as a shape with a head and a base or tail.

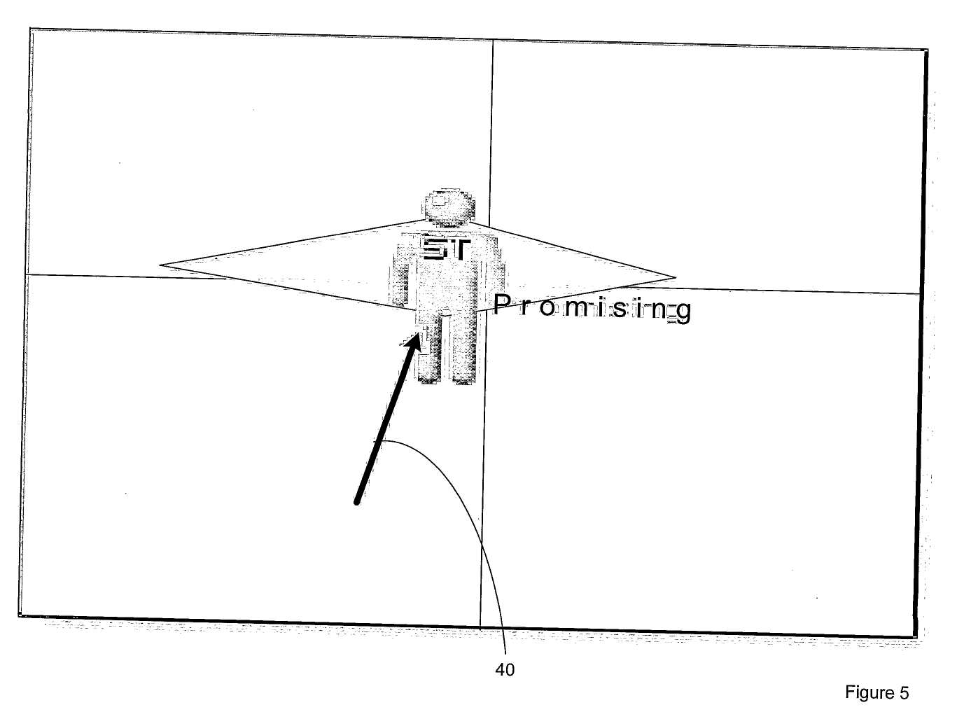

Referring to FIG. 5, an arrow 40 with a long tail is displayed with an orientation of bottom-left to top-right. This arrow indicates that historically an individual has moved significantly from their historical last position in terms of evaluation to their current position on the grid, moving away from the underperforming area of the grid and toward the starring area of the grid.

The arrow is representative of change from a number of aspects. Information can be conveyed and understood through the use of a key in terms of the length, thickness, colour, colour density, and direction of the arrow generated under each individual profiled on the grid.

The arrow graphically shows the speed in change of position of the individual. For example, with a long arrow, this would indicate that the individual has progressed or regressed (dependant on the direction of the arrow) in a very rapid fashion over the period of time they have been evaluated. The arrow is calculated using all historical information as well as information from the current evaluation.

The arrow can also graphically show the acceleration of change of position of the individual. This is calculated using an algorithm which gives more weight to more recent historical positions. For example, acceleration of change might be shown using colour blended from red (slow acceleration) to green (fast acceleration).

In an alternative embodiment of the invention, the arrow can also graphically show changes in direction of the trend over time by using curve fitting technology to produce a curved tail for the arrow.

The arrow can have a multitude of various sizes and shapes that can be used to display changes in progression or regression of an individual over time, and allows a user to quickly understand whether an individual is moving towards the starring area or the underperforming area without having to understand or read a high degree of text-based information.

Being able to quickly understand how an individual is trending in performance is equally as important as understanding their current position; in that it helps a manager formulate a correct response. For instance, if an individual's arrow indicates that they have started to drop in performance the manager needs to identify the problem to arrest the slide.

### Visually Faded Representations of Data to Indicate Data Age

In a preferred implementation all individual evaluations (historical and current) are stored in a database. The historical evaluations and current evaluations for an individual may be extracted and visually analysed to help understand their current position as well as whether they are progressing or regressing.

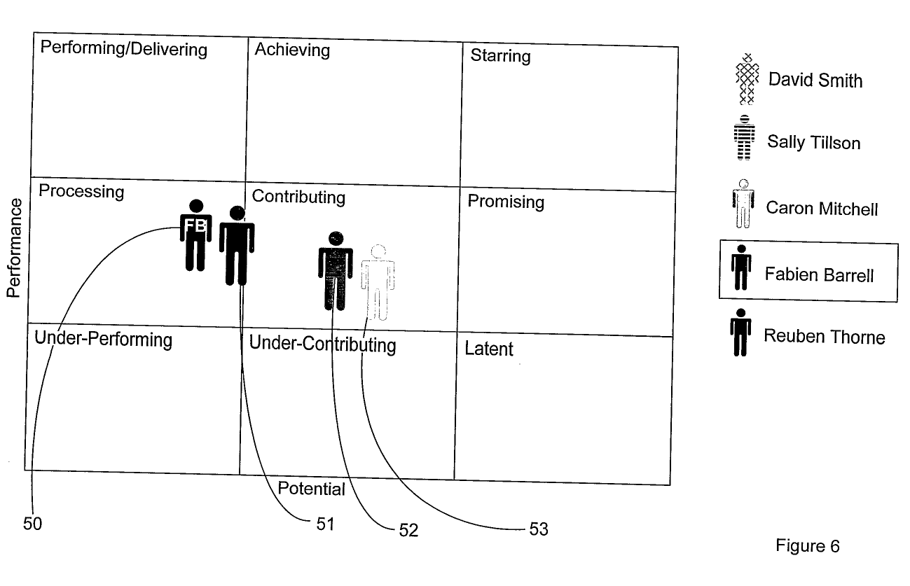

To assist the user in coming to an understanding about the individual's position a method of the invention displays data from the individual's evaluations using icons and kites, and the icons and kites are faded in dependence on the age of the data. As shown in FIG. 6, the most current evaluation's scores will be displayed with a solid graphic 50, historical scores are displayed with faded graphics 51 to 52 to 53, the older the assessment the more faded the graphic.

The faded historical icons show the history of the employee's position on the grid. This provides the user with the ability to assess the consistency of the employee's scores, as well as to identify trends in the score of the employee. It provides a visual answer to the question “Is the person getting better, are they getting worse, are they static, or are they inconsistent?” Depending on the answer to that question, there is often a different management response required.

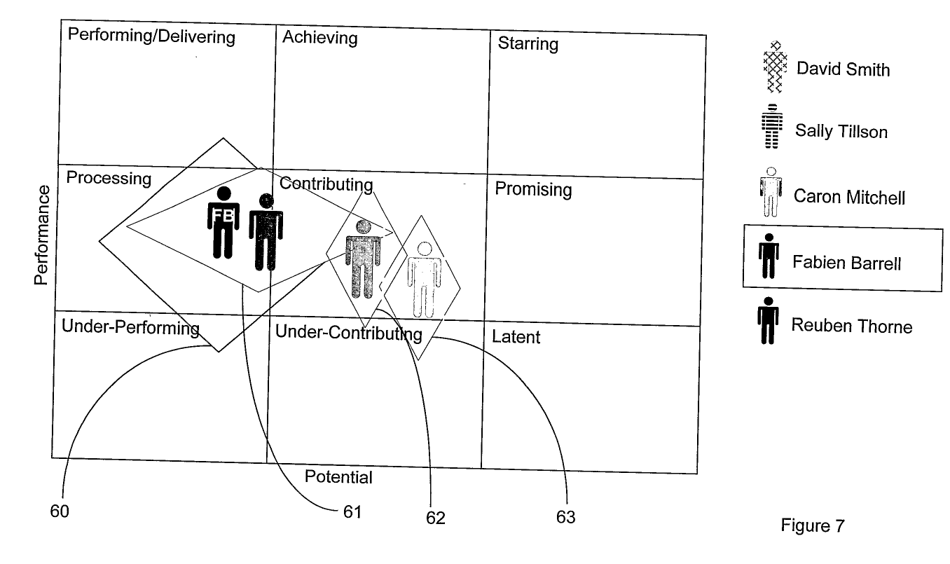

The advantage of this method is that it provides increased effectiveness the more historical data is available. As shown in FIG. 7, in conjunction with the first method of the invention, after an individual is evaluated against the core factor sets of performance and potential, a kite 60 can be generated and displayed. As the system has stored previous evaluation data in a database and it is readily accessible, a more complete picture can be presented on the grid for the individual by displaying a kite for each historical evaluation (kites 61, 62 and 63) as well. This permits the user to quickly ascertain whether the overall size of the kite across both axes is increasing or decreasing in area and size.

### An Expert System for Providing an Analysis of Talent Management Data

A further aspect of the invention is an expert system that provides both written and graphical analysis of an individual's data, such as that collected in step 1, in order to provide a user of the system guidance when making talent management decisions about individuals within an organisation.

The expert system includes the analysis of four factors:
i) The individual's current position on the grid as determined in step 3.
ii) The individual's direction of travel on the grid over time. To calculate this the expert system analyses historical ratings for a person, then uses this data to build a path and trajectory for the person, that includes factors like: their direction of movement on the grid; their speed of movement on the grid; changes in their direction of movement on the grid; and the acceleration or deceleration of their movement on the grid. For example, this can be the trend determined in step 5.
iii) The size, shape and position of the individual's kite on the grid as determined in step 4.
iv) The individual's strengths and weaknesses as measured by their rating against factors from the evaluations in step 1.

It will be appreciated that the expert system may only utilise some of the four factors. However, use of all four factors provides an advantage of completeness for the analysis.

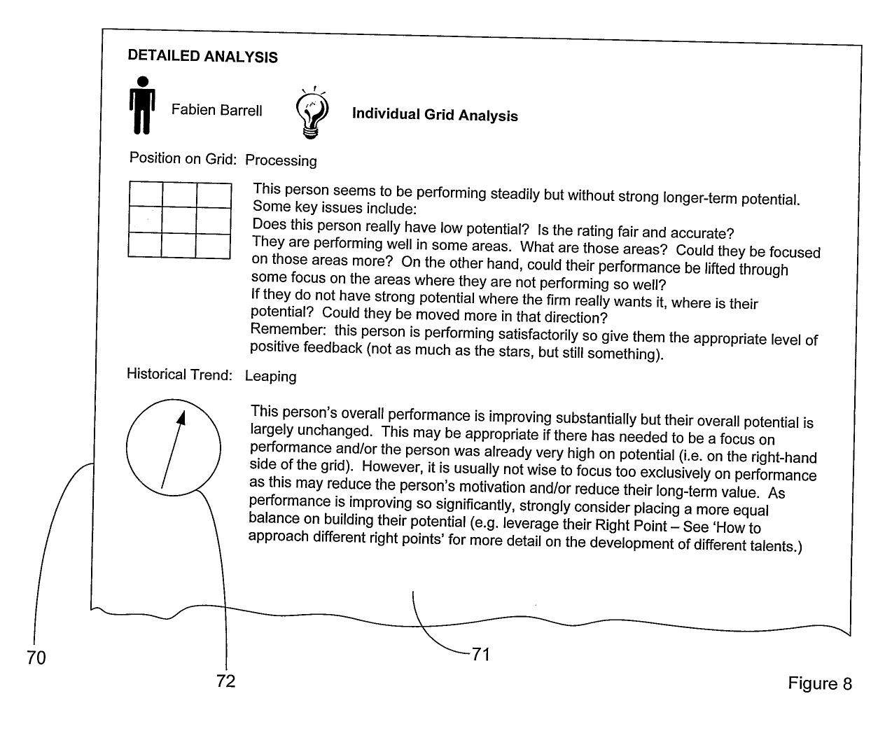

For each of these factors, the system compares the data point of the individual against a library (knowledge database) of possible data points for each analysis factor. Referring to FIG. 8, when the system finds a close match between the analysed data point and a data point in the library, the system then returns the expert advice 70 stored against that data point in the library. This advice includes text 71 and corresponding graphics 72. The text within the database can be customised depending on the organisation and is based on an understanding of what the type of movement described by the data point typically represents from a talent perspective.

For example, the data stored on an individual is analysed by the expert system for factor (ii). The analysis of the individual's data creates the following data point:
Direction of travel 47 degrees;
Speed of travel 1.32 chart segments per year;
Changes in direction: U-turn within last year;
Deceleration: Slowing at a factor of 0.22 chart segments per year per month.

The closest match to this data point in the library is Factor (ii) Data Point sixteen which is described as:
Direction of travel 45 degrees;
Speed of travel 1.5 chart segments per year;
Changes in direction: U-turn within last year;
Deceleration: Slowing at a factor of 0.25 chart segments per year per month.

The system then returns the text and graphic for Factor (ii) Data Point sixteen.

Interactive Grid for Display of Multiple Individuals within an Organisation

Another aspect of the invention is a method to display multiple individuals within an organisation on a grid of performance to potential factors using evaluation data and receive input from the user to display further detail extracted from the evaluation data in graphical and textual form.

This method has the following steps:

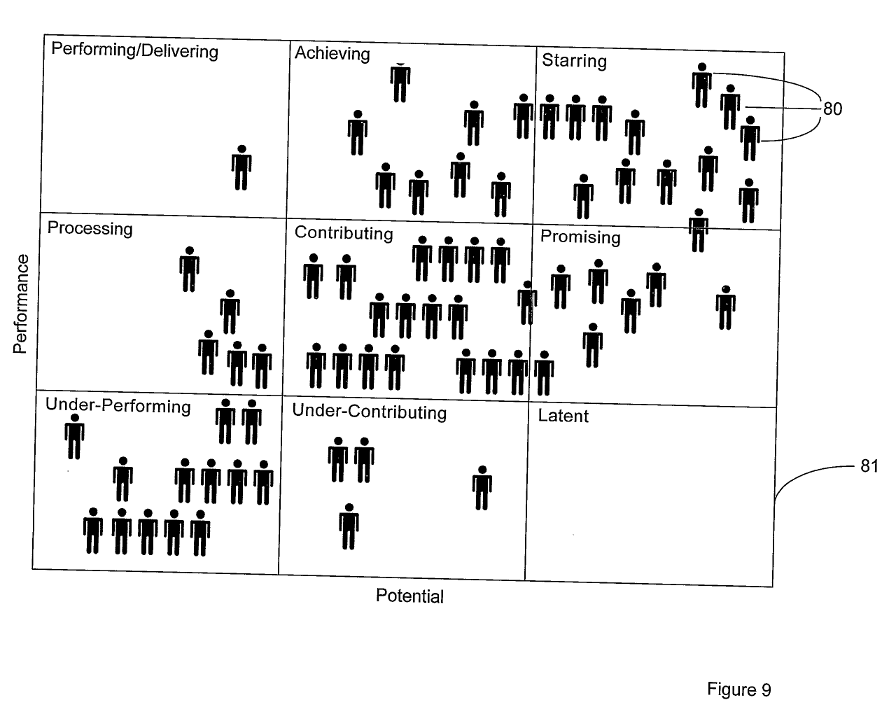

a) Displaying an entire organisation on a single grid. Referring to FIG. 9, the method utilises the data for the individuals evaluated in step 1 for all the business units within the organisation then displays that data represented as icons 80 for the individuals on the grid 81. The benefit of this is that it allows a manager to be able to view the “talent picture” across the whole organisation.

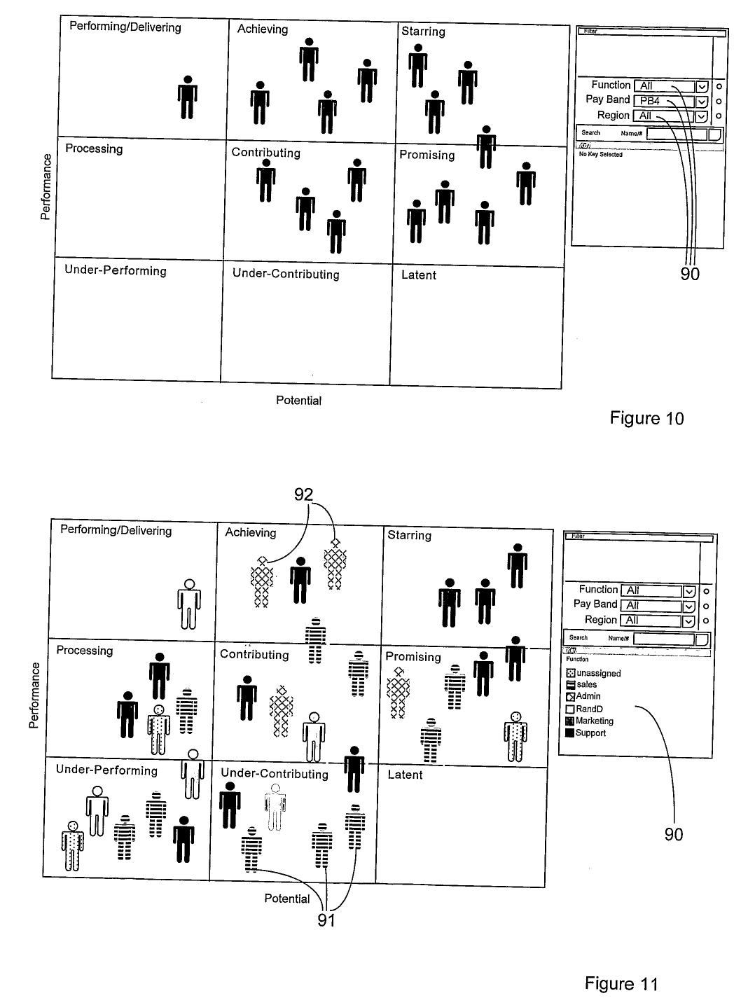

b) Filters. Referring to FIG. 10, the method receives input from the user to select single parts of the organisation by using a variety of customisable filters 90 to display only individuals within those parts. For instance the user can display only individuals performing a specific function, or from a specific region. This is particularly useful for two reasons: firstly to be able to usefully compare or analyse the profile of separate sections of the business, and secondly to be able to break a very large organisation down into useable sections that are of interest to the specific user.

c) Keys. Referring to FIG. 11, the method receives input from the user to apply a colour code 90 (key) to the data on the grid in any one of several ways such that individuals with different characteristics are displayed in different colours. For instance employees in sales might be displayed in red 91, employees in marketing in blue 92. This allows the user to quickly ascertain a graphical view of the difference (or similarities) between people with different characteristics (i.e. to compare sales and marketing).

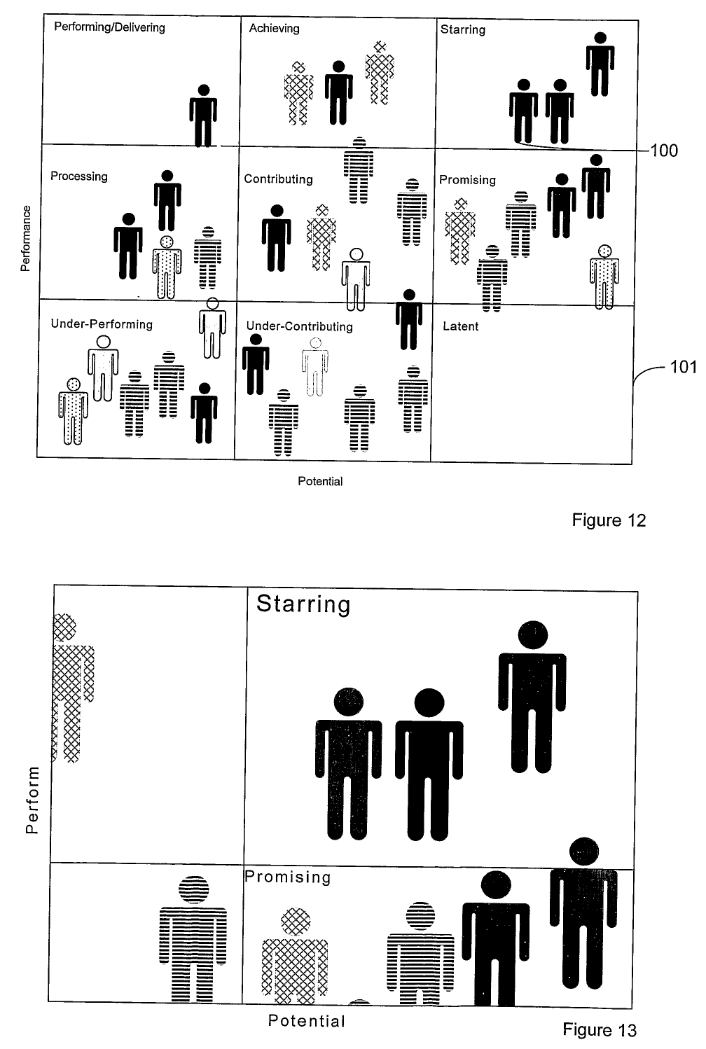

d) Zooming. Referring to FIG. 12, the method receives input from the user zoom in on a specific section 100 of the grid 101. This allows more detail to be seen as shown in FIG. 13, particularly when many individuals are displayed on the grid causing overlap of icons representing the individuals in portions of the grid.

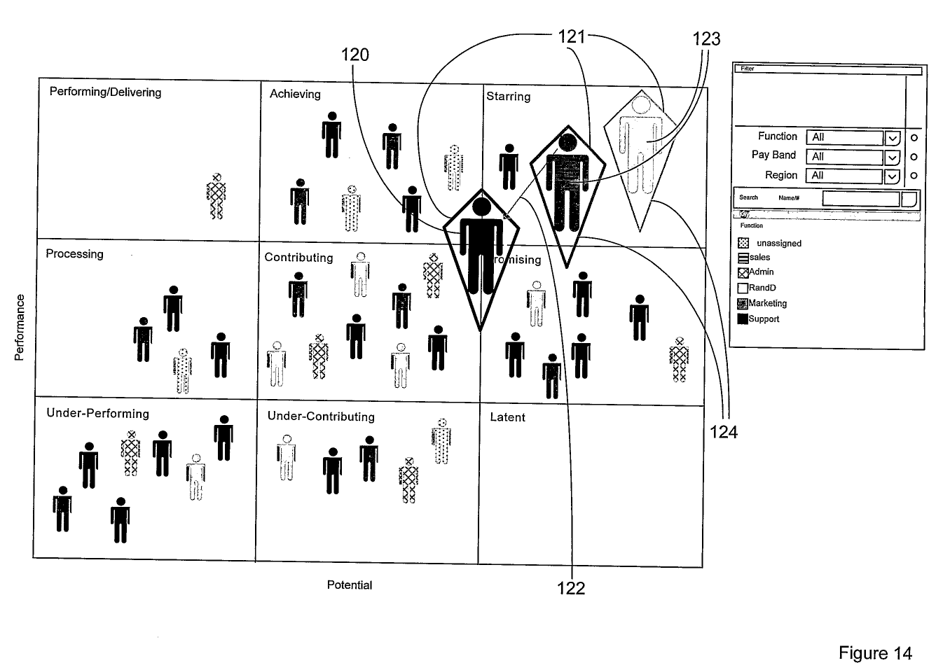

e) Drilling down. Referring to FIG. 14, the method receives input from the user to select an individual's icon by clicking on the icon within the grid. Once the user selects the icon 120 the method displays evaluation data about the selected individual as described in previous aspects to show strengths and weaknesses using kites 121, trends using arrows 122, historical data using faded icons 123 and kites 124, and expert system analysis. This permits the user to analyse individuals within the context of the whole organisation.

An additional advantage of the present invention is that the combination of evaluation information and the interactive and graphical methods of interfacing with a user provide a useful alternative over the prior art.

It will be appreciated that, although two-dimensional grids have been used to describe the graphing of evaluation data about individuals within an organisation, a three-dimensional grid could be used as well. However, two-dimensional grids are preferred in that they permit ease of use.

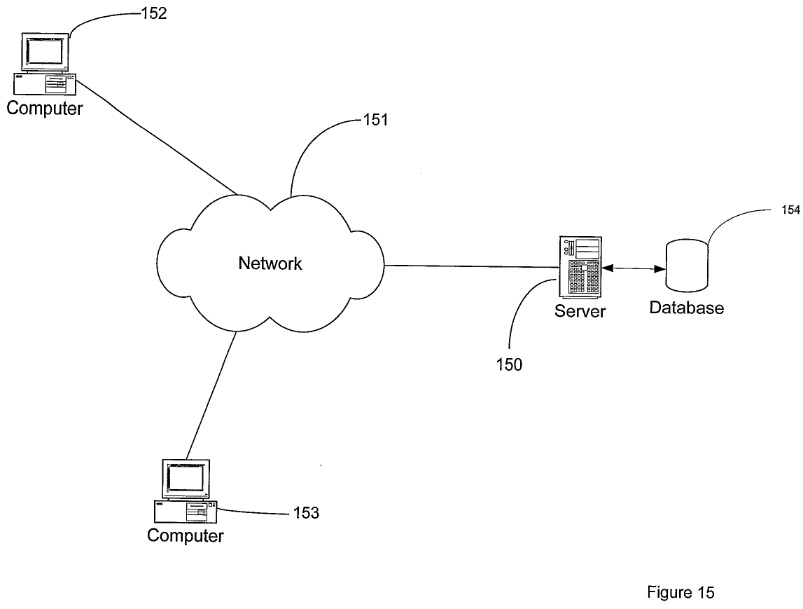

Referring to FIG. 15, a deployment of the system will be shown.

A server 150 records data relating to all employees within the organisation.

A computer 152 can connect to the server 150 via a LAN or the Internet 151. The user on computer 152 sets factor levels for the employees within a GUI. Computer 152 transmits the factor levels to the server.

The server 150 collates the factors within a database 154.

A user on computer 153 requests information relating to one or more individuals using a GUI.

The server 150 transmits data relating to the information request from the database to computer 153.

Computer 153 displays any of a kite, an arrow, historical kites, historical arrows, or an icon for each individual requested within a grid in a GUI. Alternatively computer 153 displays analysis automatically generated by an expert system based on the stored factor data for the individual.

The user on computer 153 viewing the information displayed to make a management decision.

The GUI can be implemented using Java. The server can be implemented using C++.

It will be appreciated that other deployments scenarios, such as within one computing device, are envisioned.

While the present invention has been illustrated by the description of the embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details representative apparatus and method, and illustrative examples shown and described. Accordingly, departures may be made from such details without departure from the spirit or scope of applicant's general inventive concept.

1-76. (canceled)

77. A computer implemented method of analyzing an individual to manage talent including the step of:
displaying a shape of at least two dimensions within a graph of at least two axes;
wherein the extent of the shape within the graph is determined by a strength and weakness of an individual for at least two attributes of each factor wherein each factor is represented on a different axis of the graph.

78. A method as claimed in claim 77 wherein the shape is a polygon.

79. A method as claimed in claim 78 wherein each vertex of the polygon corresponds to one of the strengths or one of the weaknesses of the individual.

80. A method as claimed in claim 78 wherein the polygon is a kite.

81. A method as claimed in claim 77 wherein the axes of the graph represent human resource metrics.

82. A method as claimed in claim 77 wherein one axis of the graph represents performance.

83. A method as claimed in claim 77 wherein one axis of the graph represents potential.

84. A method as claimed in claim 77 wherein the graph has only two axes.

85. A method as claimed in claim 77 including the step of:
displaying within the graph a plurality of shapes, each shape corresponding to a unique individual and extent of each shape within the graph determined by at least two strengths and at least two weaknesses of the corresponding individual.

86. A method as claimed in claim 77 including the step of:
displaying within the graph a plurality of historical shapes, the extent of each shape within the graph determined by at least two strengths and at least two weaknesses of the individual using historical data.

87. A method as claimed in claim 86 wherein at least some of the historical shapes are visually faded dependent on the age of the historical data.

88. A method as claimed in claim 77 where a plurality of shapes are displayed on the graph, wherein at least some of the shapes are semi-transparent such that the extent of overlapping shapes can be visually determined.

89. A method as claimed in claim 77 wherein within at least part of the shape there is an icon representing the individual.

90. A method as claimed in claim 89 wherein the icon is within the middle of the shape.

91. A method as claimed in claim 77 including the step of displaying further detail about the individual in response to a user action.

92. A method as claimed in claim 91 wherein the user action is placing a pointer over the icon.

93. A method as claimed in claim 92 wherein the user action is activation of the icon.

94. A method as claimed in claim 92 wherein further detail includes an analysis of the individual created by an automated method.

95. A method as claimed in claim 94 wherein the automated method utilizes the extent of the shape to determine at least part of the analysis.

96. A computer implemented method of analyzing an individual associated with a directional indicator positioned within a graph of at least two axes to manage talent including the step of:
displaying the directional indicator within the graph;
wherein the indicator is calculated from one or more historical evaluations of the individual such that the indicator shows a trend of the historical evaluations for the individual over time.

97. A method as claimed in claim 96 wherein the axes of the graph represent human resource metrics.

98. A method as claimed in claim 96 wherein one axis of the graph represents performance.

99. A method as claimed in claim 96 wherein one axis of the graph represents potential.

100. A method as claimed in claim 96 wherein the graph has only two axes.

101. A method as claimed in claim 96 wherein the size of the indicator is determined by the significance of change in position of the individual.

102. A method as claimed in claim 96 wherein the indicator has a first graphical characteristic determined by the speed in change of position of the individual.

103. A method as claimed in claim 102 wherein the first graphical characteristic is the length of the indicator.

104. A method as claimed in claim 102 wherein the indicator has a second graphical characteristic determined by the acceleration of change of position of the individual.

105. A method as claimed in claim 104 wherein the second graphical characteristic is the thickness of the indicator.

106. A method as claimed in claim 96 wherein the indicator is calculated using an algorithm which gives more weight to earlier historical positions.

107. A method as claimed in claim 96 wherein the indicator is an arrow.

108. A method as claimed in claim 96 wherein the method including the step of displaying an icon representing the individual within the graph.

109. A method as claimed in claim 96 wherein the indicator is pointing towards the icon.

110. A method as claimed in claim 96 including the step of displaying further detail about the individual in response to a user action.

111. A method as claimed claim 110 wherein the user action includes the step of placing a pointer over the icon representing the individual.

112. A method as claimed in claim 110 wherein the user action is activation of the icon.

113. A method as claimed in claim 110 wherein the further detail includes an analysis of the individual created by an automated method.

114. A method as claimed in claim 113 wherein the automated method utilizes the characteristics of the indicator to determine at least part of the analysis.

115. A method as claimed in claim 96 wherein the indicator is curved to indicate a non-linear change of position of the individual in relation to the historical positions.

116. A computer implemented method of analyzing an individual for managing talent including the steps of:
displaying a first graphical representation of a first set of data of an individual in a first shade of a colour on a graph; and
displaying a second graphical representation of a second set of data for the individual in a second shade of the colour on the graph;
wherein the first set of data relates to an analysis of the individual at a later time than the second set of data, and the second shade is lighter than the first shade.

117. A method as claimed in claim 116 wherein the first and second graphical representations are shapes.

118. A method as claimed in claim 116 wherein the first and second graphical representations are icons.

119. A computer implemented method of analyzing an individual to manage talent including the step of:
automatically calculating a talent analysis of the individual based on the position of an icon representing the individual within a graph of at least two axes and at least one further characteristic of the individual;
wherein each axis of the graph represents a single human resource attribute.

120. A method as claimed in claim 119 wherein the step of automatic calculation is performed using an expert system.

121. A method as claimed in claim 119 wherein the human resource attributes represented by the axes include at least one from the set of performance and potential.

122. A method as claimed in claim 119 wherein one of the further characteristics are features of the shape.

123. A method as claimed in claim 119 wherein one of the further characteristics are features of the directional indicator.

124. A computer implemented method of analyzing talent management within an organization including the steps of:
i) a user defining attribute data for a plurality of individuals within the organization using an interactive talent management tool;
ii) determining a position for an icon representing each individual within a graph using the individual's attribute data; and
iii) displaying an icon corresponding to each individual at the position of the individual within the graph such that icons representing a range of the plurality of individuals are displayed based on an attribute associated with the individuals selected by the user;
wherein the graph is of at least two axes and each axis corresponds to a human resource metric.

125. A method as claimed in claim 124 wherein one axis of the graph represents performance.

126. A method as claimed in claim 124 wherein one axis of the graph represents potential.

127. A method as claimed in claim 124 wherein the graph has only two axes.

128. A method as claimed in claim 124 including the step of displaying at least one shape associated with an icon.

129. A method as claimed in claim 128 wherein the step of displaying the shape is dependent on activation by a user of the associated icon.

130. A method as claimed in claim 124 wherein the icons are colour-coded in dependence on a factor.

131. A method as claimed in claim 130 wherein the factor is any one of pay band, region, and function.

132. A method as claimed in claim 130 wherein a user selects the factor.

133. A method as claimed in claim 124 including the steps of:
a user selecting a portion of the graph; and then
displaying the portion of the graph larger, such that the icons within that portion are displayed further apart from one another.

134. A method as claimed in claim 133 wherein the user selects the portion of the graph by clicking a pointer within the centre of the portion.

135. A method as claimed in claim 124 including the step of displaying at least one directional indicator associated with an icon.

136. A method as claimed in claim 77 including the step of displaying at least one directional indicator for the individual.

137. A system for analyzing an individual to manage talent including:
a database arranged for storing a value for a plurality of factors for each of performance and potential for the individual;
a processor arranged for determining the highest performance factor, the highest potential factor, the lowest performance factor, and the lowest potential factor for the individual; and
a display device arranged for displaying a shape within a graph of at least two axes, the extent of the shape within the graph determined by the highest and lowest factors of the individual, wherein each factor is represented on a different axis of the graph.

138. A system for analyzing an individual associated with a directional indicator positioned within a graph of at least two axes to manage talent including:
a database arranged for storing a plurality of evaluations for the individual, including one or more historical evaluations and a current evaluation;
a processor arranged for calculating the characteristics of the directional indicator; and
a display device arranged for displaying the directional indicator within the graph;
wherein the characteristics of the indicator are calculated from one or more historical evaluations for the individual such that the indicator shows a trend of the historical evaluations for the individual over time.

139. A system for analyzing an individual for managing talent including:
a database arranged for storing a first and second set of data for an individual;
a display device arranged for displaying a first graphical representation of the first set of data in a first shade of a colour on a graph and displaying a second graphical representation of the second set of data in a second shade of the colour on the graph;
wherein the first set of data relates to an analysis of the individual at a later time than the second set of data, and the second shade is lighter than the first shade.

140. A system for analyzing an individual to manage talent including:
a processor arranged for automatically calculating a talent analysis of the individual based on the position of an icon representing the individual within a graph of at least two axes and at least one further characteristic of the individual;
wherein each axis of the graph represents a single human resource attribute.

141. A system for analyzing talent management within an organization including:
a processor arranged for executing an interactive talent management tool, wherein the interactive talent management tool is arranged for interacting with a user to define attribute data for a plurality of individuals within the organization;
a processor arranged for determining a position of an icon representing each individual within a graph using the individual's attribute data; and
a display device arranged for displaying the icon within the graph such that icons representing a range of the plurality of individuals are displayed based on an attribute associated with the individuals selected by the user;
wherein the graph is of at least two axes and each axis corresponds to a human resource metric.

142. Software for analyzing an individual to manage talent including:
a database arranged for storing a value for a plurality of factors for each of performance and potential for the individual;
a module arranged for determining the highest performance factor, the highest potential factor, the lowest performance factor, and the lowest potential factor for the individual; and
a module arranged for displaying a shape within a graph of at least two axes, the extent of the shape within the graph determined by the highest and lowest factors of the individual, wherein each factor is represented on a different axis of the graph.

143. Software for analyzing an individual associated with a directional indicator positioned within a graph of at least two axes to manage talent including:
a database arranged for storing a plurality of evaluations for the individual, including one or more historical evaluations and a current evaluation;
a module arranged for calculating the characteristics of the directional indicator; and
a module arranged for displaying the directional indicator within the graph;
wherein the characteristics of the indicator are calculated from one or more historical evaluations for the individual such that the indicator shows a trend of the historical evaluations for the individual over time.

144. Software for analyzing an individual for managing talent including:
a database arranged for storing a first and second set of data for an individual;
a module arranged for displaying a first graphical representation of the first set of data in a first shade of a colour on a graph and displaying a second graphical representation of the second set of data in a second shade of the colour on the graph;
wherein the first set of data relates to an analysis of the individual at a later time than the second set of data, and the second shade is lighter than the first shade.

145. Software for analyzing an individual to manage talent including:
a module arranged for automatically calculating a talent analysis of the individual based on the position of an icon representing the individual within a graph of at least two axes and at least one further characteristic of the individual;
wherein each axis of the graph represents a single human resource attribute.

146. Software for analyzing talent management within an organization including:
a module arranged for executing an interactive talent management tool, wherein the interactive talent management tool is arranged for interacting with a user to define attribute data for a plurality of individuals within the organization;
a module arranged for determining a position of an icon representing each individual within a graph using the individual's attribute data; and
a module arranged for displaying the icon within the graph such that icons representing a range of the plurality of individuals are displayed based on an attribute associated with the individuals selected by the user;
wherein the graph is of at least two axes and each axis corresponds to a human resource metric.

147. A system arranged for performing the method as claim 77.

148. Software arranged for performing the method as claimed in claim 77.

149. Storage media storing software as claimed in claim 142.

150. A computer implemented method of analyzing an individual to manage talent substantially as herein described with reference to FIGS. 1 to 14.

151. A computer implemented method of analyzing an individual positioned within a graph of at least two axes to manage talent substantially as herein described with reference to FIGS. 1 to 14.

152. A computer implemented method of analyzing talent management within an organization substantially as herein described with reference to FIGS. 1 to 14.

153. A method as claimed in claim 77 wherein the extent of the shape within the graph is determined by a strength and weakness of an individual for three or more attributes.
